(19) United States
(12) Patent Application Publication
(10) Pub. No.: US 2006/0192314 A1
(43) Pub. Date: Aug. 31, 2006

(54) Method and device for forming a mat of material

(75) Inventors: Carl-Johan Soderberg, Sundsvall (SE); Ulrika Backlund, Sundsvall (SE); Jan Detlefsen, Alno (SE); Lena Backman, Sundsvall (SE)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Metso Paper Sundsvall AB, Sundsvall (SE)

(21) Appl. No.: 10/545,576

(22) PCT Filed: Feb. 16, 2004
(86) PCT No.: PCT/SE04/00200

§ 371 Date: Aug. 16, 2005

(30) Foreign Application Priority Data
Feb. 17, 2003 (SE) 0300418-1

(51) Int. Cl. B27N 3/02; B27N 3/10

(52) U.S. Cl. 264/109; 425/363

(57) ABSTRACT

A method and device for forming a mat of material containing lignocellulose, which mat is intended to form at least one board, disintegrated material containing lignocellulose being fed to a feeding out unit, and from this being fed in the form of a material flow to a forming unit (200) comprising at least one forming belt (207), the feeding out unit being positioned at a higher level than the forming unit (200). At least one feeding down surface (14) is arranged which extends from the feeding out unit to the forming unit (200), and the transport of material between the feeding out unit and the forming unit (200) is effected by feeding the material downwards along this feeding down surface (14), whereby a controlled material flow is provided between these units.

### TECHNICAL FIELD

The present invention relates to a method and device for forming a mat of material containing lignocellulose, which mat is intended to form at least one board, disintegrated material containing lignocellulose being fed to a feeding out unit and from this being fed in the form of a material flow to a forming unit comprising at least one forming belt, the feeding out unit being positioned at a higher level than the forming unit.

### BACKGROUND OF THE INVENTION

Upon producing boards of material containing lignocellulose, such as particle boards and fibreboards according to the dry method (MDF, HDF, LDF etc.), first the material containing lignocellulose is disintegrated into particles or fibre bundles. Subsequently these are dried and glue-coated and formed to a continuous mat in one or several forming stations. The mat is pre-pressed and subsequently finish-pressed to boards under pressure and heat in a continuous or discontinuous press.

The material containing lignocellulose can be mixed with other materials, for example plastics, waste paper, glass fibres, disintegrated minerals etc., prior to forming or under the forming process. Upon producing boards it is essential that these have homogeneous properties over the whole board surface. These properties are, inter alia, thickness, transverse tensile strength, bending and breaking strength, painting properties etc. Since these properties are dependent on the density of the board, it is important that the forming is effected with a good precision so that the density of the board is the same over the whole board surface. In order to achieve this, during the forming process the particles or fibre bundles must be distributed as homogenously as possible both longitudinally and transversely over the whole formed surface.

Conventional forming equipments for forming boards of material containing lignocellulose are often mechanical. These usually comprise at least one feeding out unit comprising a dosing bin or dosing container where the material is intermediately stored and subsequently is dosed down, free falling, to a forming unit where the material is laid down on a forming belt, i.e. a conveying belt. Further, upon producing fibre boards a scalping roll is often used subsequent to forming, which mills off any unevenness in the mat surface to improve the forming precision.

A drawback of the conventional forming equipments is that the material during its free fall between the feeding out unit and forming unit easily can be affected by surrounding air flows both longitudinally and transversely, whereby the forming precision is impaired. Free fall, where this problem is present, arises, as mentioned above, during the fall between the feeding out unit and forming unit and also, depending on machine type, in the fall from the rolls of the forming unit down onto the forming belt.

During a free fall of a material flow in air, two inconvenient phenomena arise. Firstly, it is prior known that a material flow falling freely in air has a tendency to get together and form several material beams. This tendency increases with an increased height of fall. Secondly, co-ejecting air streaming and decelerating or air-breaking effects arise. These air streams drag long material and also make the fall shaft, which surrounds the material flow, non-transparent due to material whirling about.

A prior method to decrease the effect of the free fall from the rolls arranged at the forming belt, so called forming rolls, down onto the forming belt, is to make these forming rolls vertically movable so that the forming rolls always are positioned close to the formed mat. SE 511 259 discloses for example how these rolls are working directly into the mat, whereby the problem with the free fall from the rolls arranged at the forming belt down onto the forming belt is eliminated. However, the problem with the free fall from the feeding out unit to the forming unit is unsolved.

### THE OBJECT OF THE INVENTION

The object of the present invention is to eliminate or at least minimize the problem with deficient homogeneity of the formed mat resulting from the effect of uncontrolled air streams on the free falling material slow between the feeding out unit and forming unit as described above, and resulting from other effects as a result of the free fall of the material flow between said units. Further, the object of the present invention is to solve further problems mentioned above.

### SUMMARY OF THE INVENTION

The solution of the present invention is to provide a method and a device providing a radical improvement of the forming process by a method of the kind defined in the preamble of claim 1 comprising the special measure that at least one feeding down surface is arranged which extends from the feeding out unit to the forming unit, and that the transport of material between the feeding out unit and the forming unit is effected by feeding the material downwards along this feeding down surface. By feeding the material flow downwards along the feeding down surface essentially along the whole distance between said units, air streams and material flow are separated, whereby a controlled material flow is provided between these units. This controlled material flow in turn enables an increased homogeneity of the formed mat and thus also in the finished board.

According to an advantageous embodiment of the method according to the present invention, the material flow is slowed down and deflected towards the horizontal plane of the forming belt as it approaches the forming unit.

According to a further advantageous embodiment of the method according to the present invention, the width of the material flow is controlled previous to the forming unit. This offers a flexible and uncomplicated variation of the width of the formed mat.

According to another advantageous embodiment of the method according to the present invention, the material flow is laterally controlling by moving adjustable lateral control means in the material flow, said means being positioned in the material flow, and turning said means in relation to the direction of motion of the material flow. Through this the homogeneous properties of the formed mat are strengthened.

According to yet another advantageous embodiment of the method according to the present invention, the distribution of the material transverse to the direction of motion of the material flow is controlled. The purpose of this is also to strengthen the homogeneous properties of the formed mat.

According to an advantageous embodiment of the method according to the present invention, the material is fed to the feeding out unit via a second feeding down surface by feeding said material downwards along this second feeding down surface to the feeding out unit, whereby a controlled material flow is also provided here. This embodiment of the method of the present invention can also be effected independently of and separated from the method according to the present invention involving the feed of material between the feeding out unit and the forming unit, and further comprise one or several of the special measures being taken according to the method of the present invention for feed of material between the feeding out unit and forming unit.

Further, the present invention provides a device for forming a mat of material containing lignocellulose, which mat is intended to form at least one board, comprising a feeding out unit and a forming unit with at least one forming belt, disintegrated material containing lignocellulose being fed to the feeding out unit and subsequently being fed to the forming unit in the form of a material flow, and where the feeding out unit is positioned at a higher level than the forming unit, the device comprising at least one feeding down surface extending from the feeding out unit to the forming unit, the feeding down surface being adapted to transport material between the feeding out unit and the forming unit by feeding the material downwards along this feeding down surface, whereby a controlled material flow is provided between these units.

According to alternative embodiments of the feeding down surface of the device according to the present invention, the feeding down surface comprises a conveying belt, a layer of rolls or a sliding plate. In the case with a sliding plate the gravity affects the downward motion of the material flow while in the case of a layer of rolls or a conveying belt, also their working speed affects the downward motion of the material flow. The sliding plate can comprise several beside one another positioned plates.

According to an advantageous embodiment of the device according to the present invention, the forming unit comprises at least one speed adaptation device, via which the material passes before being laid down onto the forming belt, designed to adapt the speed of the material to the speed of the forming belt. The speed adaptation device comprises for example a diffusion roll which preferably is vertically adjustable.

According to a further advantageous embodiment of the device according to the present invention, width control means adapted to control the width of the material flow previous to the forming unit are arranged along at least one of the longitudinal sides of the feeding down surface.

According to another advantageous embodiment of the device according to the present invention, adjustable lateral control means adapted to laterally control the material flow are positioned in the material flow, the lateral control means being movable in the material flow and pivotally in relation to the direction of motion of the material flow.

According to yet another advantageous embodiment of the device according to the present invention, material distribution means, adapted to control the distribution of the material transverse to the direction of motion of the material flow, are arranged at the feeding down surface.

According to an advantageous embodiment of the device according to the present invention, a second feeding down surface is arranged to feed material to the feeding out unit by feeding said material downwards along this second feeding down surface to the feeding out unit, whereby a controlled material flow is also provided here. This embodiment can also be provided independently of and separated from the device according to the present invention involving the feed of material between the feeding out unit and the forming unit, and further comprise one or several of the special features of the device according to the present invention for feed of material between the feeding out unit and forming unit.

Further, the present invention provides a method for producing boards of material containing lignocellulose, which method comprises the measure of forming a mat from disintegrated material, the method comprising the special measures mentioned in any of the claims 1 to 8.

The present invention also provides a plant for producing boards of material containing lignocellulose, which plant comprises a device for forming a mat, said device comprises the special features mentioned in any of the claims 9 to 22.

Such an arranged method and such a designed plant, respectively, for producing boards present those advantages described above regarding the method for forming a mat.

As described above in the disclosure of the background of the invention, material does not only refer to material containing lignocellulose but also possible addition of any materials, such as plastics, waste paper, glass fibres, disintegrated minerals etc. The material can be of different sizes and forms and for example comprise fibres and/or fibre bundles

Further advantageous embodiments of the present invention emerge from the appended claims.

### BRIEF DESCRIPTION OF THE DRAWINGS

The present invention will now be described, for exemplary purposes, in more details by way of embodiments and with reference to the enclosed drawings, in which:

FIG. 1 is a schematic side view of a conventional mechanical forming equipment for boards;

FIG. 2 is a side view of an embodiment of a feeding down surface according to the present invention;

FIG. 3 is a view of an embodiment of a feeding down surface with width control means according to the present invention;

FIG. 4 is a side view of an embodiment of a feeding down surface with lateral control means according to the present invention;

FIG. 5 is a side view of an embodiment of a feeding down surface with material distribution means according to the present invention; and

FIG. 6 is a schematic side view of a mechanical forming station for boards with a second feeding down surface arranged at the feeding out unit.

### DETAILED DESCRIPTION OF THE DRAWINGS

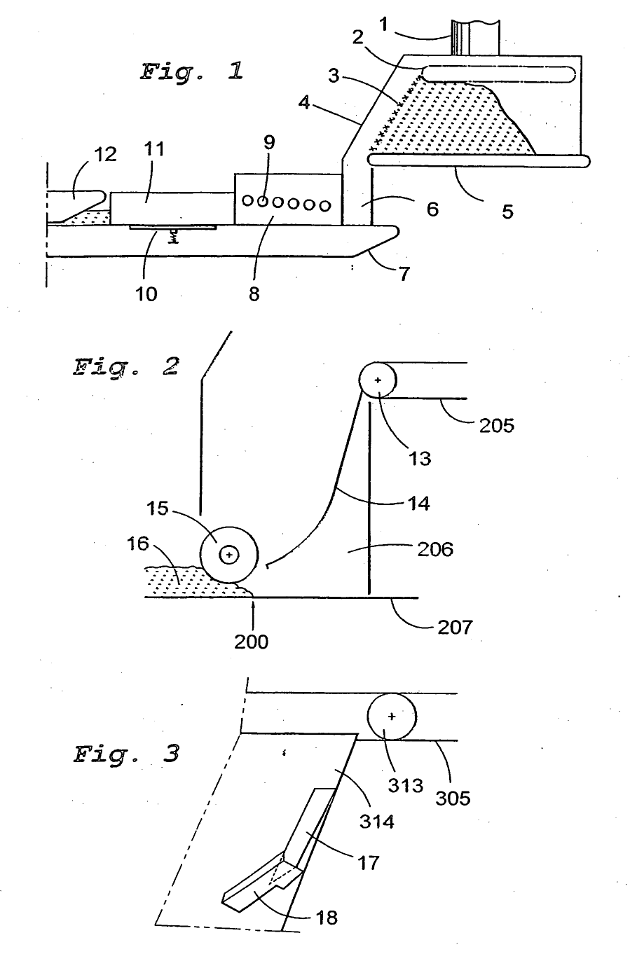

FIG. 1 shows a conventional forming equipment for boards. The material is fed in via an inlet 1 to a feeding out unit 4, here in the form of a dosing bin. The feeding out unit 4 has an upper feeding back equipment 2, which feeds material, which has been fed in, to the right in the feeding out unit, feeding out rolls 3 and bottom conveying belt 5 which feeds the material to the left towards the outlet of the feeding out unit 4. After feeding out via the feeding out rolls 3 the material falls down in the fall shaft region 6 and can subsequently fall down directly onto a forming belt 7 or onto a layer of rolls 9 arranged in a forming station 8, in which forming station 8 a mat is formed. The weight of the mat is continuously checked by a scale unit 10 and data from the scale unit 10 are used for controlling the speed of the bottom conveying belt 5. The sides of the mat are supported by sidewalls 11 before the entry into a pre-press 12.

FIG. 2 shows a fall shaft region 206 where a feeding down surface 14 according to the present invention is arranged extending between the feeding out unit and a forming unit 200. The term forming unit is used here as a generic term for all the different parts and devices which can be used for forming a mat, for example forming belt, rolls, forming station, scale etc. A bottom conveying belt 205 in the feeding out unit is driven by a drive roll 13. The terminal edge of the upper portion of the feeding down surface 14 which here comprises a sliding plate, but also can comprise a conveying belt or a layer of rolls, is arranged close to and just below the horizontal plane through the centre of rotation of the drive roll 13. In those cases the feeding out unit comprises so called tearing rolls comprising two counter-rotating rolls with different speeds usually positioned just below the drive roll 13, the terminal edge of the upper portion of the feeding down surface 14 is positioned under the tearing roll having the higher speed. In those cases where the feeding out unit is positioned as the feeding out unit 4 in FIG. 1, the tearing roll having the higher speed is positioned closest to the bottom conveying belt 205 of the feeding out unit in relation to the other tearing roll. In those cases where the feeding out unit is inverted in relation to the feeding out unit 4 in FIG. 1, is positioned above the forming station 8 in FIG. 1, and has its outlet to the forming unit 200 to the right in FIG. 1, the tearing roll with the higher speed is positioned furthest away from the bottom conveying belt 205 of the feeding out unit in relation to the other tearing roll. The material is fed out from the feeding out unit to the upper portion of the sliding plate 14 which is sloping downwards forming an angle of 15-35 degrees, preferably 20-30 degrees, with the vertical plane, to catch and slow down the material from the feeding out unit in the best way. When the material hits the sliding plate 14 the material is separated from the co-ejecting air, and a material flow in the form of a relatively thin layer is sliding downwards along the sliding plate 14 which further down and closer to the forming unit 200 forms a curved surface, the surface preferably having a curve having a radius of 500-800. This curve further slows down the material flow and deflects the material flow towards the horizontal plane. The material flow leaves the sliding plate 14 and passes through a speed adaptation device arranged in the forming unit 200 in the form of a diffusion roll 15 which further adapts the speed of the material flow to the speed of the forming belt 207. The diffusion roll 15 is vertically adjustable and is rotated clockwise in the figure with an angular speed adapted to the forming belt 207 in such a way that an even mat thickness is provided on the forming belt 207 after the diffusion roll 15. The forming belt 207 in this figure is running to the left for further transport of the mat to the following units of the forming unit 200 where the mat obtains its final form. Tests have shown that without a diffusion roll 15, a wavelike pattern is formed in the longitudinal extension of the mat which results in a varying board density. Preferably, the shortest horizontal distance between the lower terminal edge of the sliding plate 14 and the outer circumference of the diffusion roll 15 is 10-150 mm, more preferably 20-100 mm. The diffusion roll 15 is designed with an open cross section allowing material with a suitable speed to pass through. Co-ejecting air is deflected upwards and backwards and is brought into recirculation. Like the diffusion roll 15, the lower terminal edge of the sliding plate 14 is vertically adjustable. This is achieved, for example, by spitting the sliding plate into two parts, the lower part being displaced in relation to the upper part and slightly turned.

FIG. 3 shows a bottom conveying belt 305 arranged in the feeding out unit, which is driven by a drive roll 313, and the upper left portion of a sliding plate 314. Width control means are provided comprising an elevating plate 17 the upper edge of which is abutting the sliding plate 314 in such a way that it captures material from the material flow which is fed down along the longitudinal sides of the sliding plate 314. The elevating plate 17 forms a greater angle with the vertical plane than the sliding plate 314 at the corresponding place, and thus elevates the material captured from the material flow. Further, the width control means comprise a directing plate 18, the captured material from the elevating plate 17 hitting the directing plate 18 which distributes the material towards the central flow of the material flow, the distribution of the material being effected above the regular material flow as the directing plate 18 is arranged at a distance from the sliding plate 314. Preferably, the directing plate 18 forms an angle of approx. 45 degrees, but can be varied to achieve the required length of the material throw. The directing plate 18 can be provided with directing profiles to improve the directing of the captured material in the direction of the central flow of the material flow. The elevating plate 17 and the directing plate 18 are continuously adjustable to offer a continuous width control of the material flow.

FIG. 4 shows a bottom conveying belt 405 arranged in the feeding out unit, which is driven by a drive roll 413, and the upper portion of a sliding plate 414. Adjustable lateral control means are controllably arranged in the front wall 21 of the fall shaft, the lateral control means comprising a directing bar 20 supported by a shaft 19. The shaft 19 can be moved in the longitudinal direction of the shaft 19 such that the directing bar 20 engages at different depths in the material flow along the sliding plate 414 and be turned so that the directing bar 20 is turned in relation to the direction of motion of the material flow. If several directing bars 20 are arranged, these are preferably laterally arranged in relation to each other, across the width of the sliding plate 414.

FIG. 5 shows how the material is falling from the feeding out unit comprising a bottom conveying belt 505 driven by a drive roll 513 down onto a sliding plate 514 where a relatively thin material flow 22 is formed. Above the sliding plate 514 material distribution means comprising a levelling roll 24 are arranged transverse to the sliding plate 514, the distance from the levelling roll 24 to the sliding plate 514 preferably being adjustable to obtain a required distance 23 between the levelling roll 24 and the sliding plate 514. Tests have shown that the usage of a levelling roll 24 improves and levels out the material distribution transverse to the sliding plate 514. The levelling roll 24 can be designed in a known manner, for example with pin units, wing units, plate units etc, so that a distributing effect is achieved. The levelling roll 24 is rotated with a higher angular speed than the speed of the material flow, and can be rotated in both directions, but preferably the levelling roll 24 is rotated in the direction of motion of the material flow. The position of the levelling roll 24 in relation to the sliding plate 514, which presents the distance 23, can be varied parallelly to the sliding plate 514 or each of the ends of the levelling roll 24 can be moved in relation to the sliding plate 514 to achieve required levelling effect.

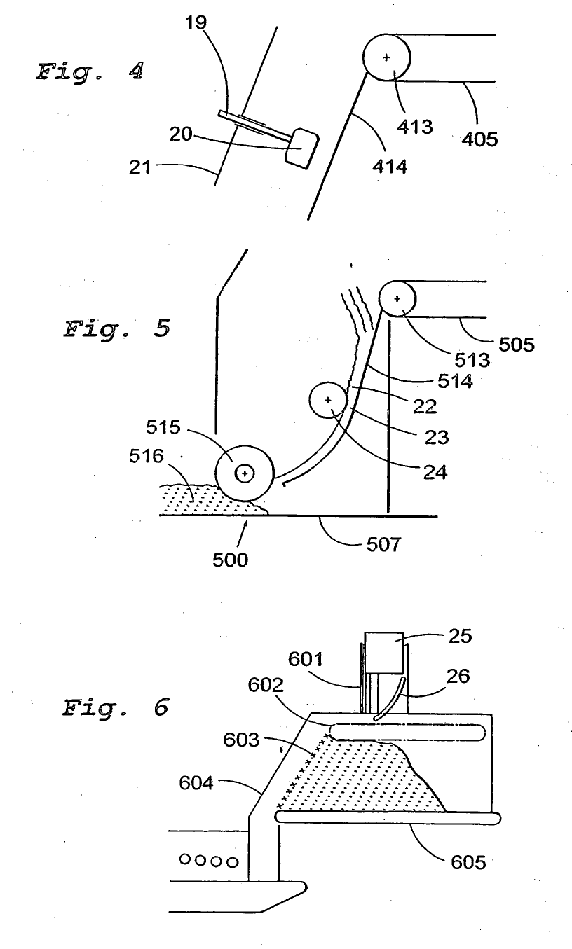

FIG. 6 shows a part of a forming equipment for boards. The material is fed in via an inlet 610 to a feeding out unit 604, the inlet 601 comprising width dosing means 25, for example in the form of a pendulum nozzle, which doses material, which has been fed in, downwards into the feeding out init across its whole width. The feeding out unit 604 comprises an upper feeding back equipment 602, feeding out rolls 603 and bottom conveying belt 605. In the inlet 601 below the width dosing means 25 is a second feeding down surface 26 arranged comprising a sliding plate, but can also comprise a conveying belt or a layer of rolls, the second feeding down surface 26 being arranged to feed material to the feeding out unit 604 by feeding down said material downwards along this second feeding down surface 26 to the feeding out unit 604, whereby a controlled material flow also is provided here. This second feeding down surface 26 can present one or several of the special features being distinguishing for the feeding down surface according to the present invention extending between the feeding out unit and the forming unit, and can be used without it and independent of it. Preferably, also the inlet to the feeding down unit of other embodiments comprises the width dosing means 25 but not necessarily this second feeding down surface 26.

1. A method for forming a mat of lignocellulose containing material intended to form at least one board, comprising feeding disintegrated lignocellulose containing material to a feeding out unit and then to a forming unit comprising at least one forming belt, said feeding out unit being positioned at a higher level than said forming unit, and feeding said material downwards along at least one feeding down surface from said feeding out unit to said forming unit, whereby a controlled material flow is provided between said feeding out unit and said forming unit.

2. A method according to claim 1, including slowing down and deflecting said material flow towards the horizontal plane of said forming belt as it approaches said forming unit.

3. A method according to claim 1 including controlling the width of said material flow previous to said forming unit.

4. A method according to claim 3, wherein said controlling of said width of said material flow comprises elevating said material to a higher level in relation to said at least one feeding down surface on at least one of the longitudinal sides of the said at least one feeding down surface, and subsequently directing and distributing said material towards the central flow of said material flow by means of adjustable width control means.

5. A method according to claim 1, including laterally controlling said material flow using adjustable lateral control means in said material flow, said adjustable lateral control means being positioned in said material flow, and turning said adjustable lateral control means in relation to the direction of motion of said material flow.

6. A method according to claim 1, including controlling the distribution of said material transverse to the direction of motion of said material flow.

7. A method according to claim 6, including controlling the distribution of said material transverse to the direction of motion of said material flow by engaging said material flow with a levelling roll arranged transverse to said at least one feeding down surface.

8. A method according to claim 1 including feeding said material to said feeding out unit by means of a second feeding down surface for feeding said material downwards along this second feeding down surface to said feeding out unit, whereby a controlled material flow is provided.

9. Apparatus for forming a mat of lignocellulose containing material intended to form at least one board, comprising a feeding out unit and a forming unit including at least one forming belt, means for feeding disintegrated lignocellulose containing material to said feeding out unit and subsequently to said forming unit in the form of a material flow, said feeding out unit being positioned at a higher level than said forming unit, at least one feeding down surface extending from said feeding out unit to said forming unit, said at least one feeding down surface being adapted to transport material between said feeding out unit and said forming unit by feeding said material downwards along said at least one feeding down surface, whereby a controlled material flow is provided said feeding out unit and said forming unit.

10. Apparatus according to claim 9, wherein said at least one feeding down surface comprises a sliding plate along which said material is fed down to said forming unit.

11. A device according to claim 9, wherein said at least one feeding down surface comprises a layer of rolls along which said material is fed down to said forming unit.

12. Apparatus according to claim 9, wherein said at least one feeding down surface comprises a conveying belt along which said material is fed down to said forming unit.

13. Apparatus according to claim 9 wherein the upper portion of said at least one feeding down surface forms an angle from 15 to 35 degrees with the vertical plane.

14. Apparatus according to claim 9, wherein the lower portion of said at least one feeding down surface forms a curved surface.

15. Apparatus according to claim 9, wherein said forming unit comprises at least one speed adaptation device through which said material passes before being laid down onto said forming belt for adapting the speed of said material to the speed of said forming belt.

16. A device according to claim 15, wherein said at least one speed adaptation device comprises a diffusion roll.

17. Apparatus according to claim 9 including width control means for controlling the width of said material flow previous to said forming unit, said width control means arranged along at least one of the longitudinal sides of said at least one feeding down surface.

18. Apparatus according to claim 17, wherein said width control means comprises at least one elevating plate adapted to elevate said material at at least one of the longitudinal sides of said at least one feeding down surface up to a higher level in relation to said at least one feeding down surface, and at least one directing plate adapted to subsequently direct and distribute said material towards the central flow of said material flow.

19. Apparatus according to claim 9 including adjustable lateral control means adapted to laterally control said material flow positioned in said material flow, said lateral control means being pivotally movable in said material flow in relation to the direction of motion of said material flow.

20. Apparatus according to claim 9, including material distribution means adapted to control the distribution of said material transverse to the direction of motion of said material flow, arranged at said at least one feeding down surface.

21. Apparatus according to claim 20, wherein said material distribution means comprises a levelling roll arranged transverse to said at least one feeding down surface.

22. Apparatus according to claim 9, including a second feeding down surface arranged to feed said material to said feeding out unit downwardly along said second feeding down surface to said feeding out unit, whereby a controlled material flow is provided.

23. A method for producing boards of lignocellulose containing material comprising forming a mat from disintegrated lignocellulose containing material and comprising the method of claim 1.

24. A plant for producing boards of lignocellulose containing material, which plant includes apparatus for forming a comprising the apparatus of claim 9.

25. A method according to claim 7, including rotating said levelling roll at a higher angular speed than the speed of said material flow.

26. Apparatus according to claim 13 wherein the upper portion of said at least one feeding down surface forms an angle of from 20 to 30 degrees with the vertical plane.

27. Apparatus according to claim 14, wherein said curved surface has a curve with a radius of form 500 to 800 mm.

28. Apparatus according to claim 16, wherein said diffusion roll is vertically adjustable.

29. Apparatus according to claim 21, wherein the distance from said levelling roll to said at least one feeding down surface is adjustable.
